(19) United States
(12) Patent Application Publication
(10) Pub. No.: US 2010/0112361 A1
(43) Pub. Date: May 6, 2010

(54) Method of removing lead, reclaimed metals and reclaimed products

(75) Inventors: Satoru Kurita, Iruma-shi (JP); Taiichi Ohno, Iruma-shi (JP); Nobuo Tajima, Iruma-shi (JP)

Correspondence Address: OLIFF & BERRIDGE, PLC, P.O. BOX 320850, ALEXANDRIA, VA, 22320-4850, US

(73) Assignee: TAMURA KAKEN CORPORATION, Iruma-Shi (JP)

(21) Appl. No.: 12/588,876

(22) Filed: Oct. 30, 2009

(30) Foreign Application Priority Data
Nov. 6, 2008 (JP) 2008-285033

(51) Int. Cl. B32B 15/04; C22B 9/00; B32B 15/01

(52) U.S. Cl. 428/457; 75/392; 75/710

(57) ABSTRACT

An object of the present invention is to provide an industrially excellent method for removing lead that is high in removal effect of lead, capable of implementing the removal even in small facilities and of suppressing capital investment cost. A material to be treated selected from the group consisting of a pure metal and an alloy is heated to obtain a melt. The melt is contacted with at least one of a metal halide and a metal oxyhalide to remove lead in the material to be treated.

This application claims the benefit of Japanese Patent Application P2008-285033 filed on Nov. 6, 2008, the entirety of which is incorporated by reference.

### TECHNICAL FIELD

The present invention relates to a technology that smelts pure metals or alloys to promote effective utilization of resources.

### BACKGROUND ART

The impurity removal techniques to acquire reclaimed solder were aimed at impurities such as Cu and Fe when solder with lead was mainly used. A method is available that involves adding an element to impurities such as Cu and Fe to form an eutectic having a melting point higher than that of tin-lead solder to thereby remove the eutectic with floating Cu and Fe by taking advantage of the melting point and specific gravity differences (Japanese Patent Publication No. S 60-56789B).

In addition, in electrolytic refining of lead, it is difficult to separate and remove lead and tin. Because of this, there is a method for refining a resulting cathode deposit with a soda compound and then repeatedly recovering lead as crude lead in a reducing furnace for lead (Japanese Patent Publication No. S 57-5829A).

Other methods in tin-lead solder such as a method for recovering lead by distillation that makes use of the difference of vapor pressures of tin, lead, and the like are also devised (Japanese Patent No. 3356571B).

In recent years, lead is extremely toxic and thus its use has been controlled worldwide from the viewpoint of the environmental protection. Therefore, tin-lead solder has been substituted by lead-free solder and the removal of a lead impurity at the recycling process of a bare metal is a subject. The following technologies are proposed as methods of removing this lead impurity.

(A) A method of recovering lead that takes a eutectic of tin and lead having a low melting point close to the melting point of lead-free solder out of a cracked pot is devised (Japanese Patent Publication No. 2003-247031A).

(B) A method of separating a metallic material to metal constituents by plasma fusion, decreasing the temperature to the vicinity of the melting point of a constituent metal to thereby control temperature and separating the metals step by step by crystal solidification is devised (Japanese Patent Publication No. 2004-162139A).

(C) A method of chemically reacting a raw material containing lead with caustic soda to recover lead with a high purity in a high yield is devised (Japanese Patent Publication No. H 07-113129A).

(D) A method of treating a raw material containing a metal with hydrochloric acid to prepare a hydrochloric acid solution of a metal ion and then adsorbing and desorbing the metal ion to cellulose to recover it is devised (Japanese Patent Publication No. 2006-348359A).

### SUMMARY OF THE INVENTION

Used pure metals or alloys are recovered, refined and remanufactured to promote effective utilization of resources. Lead is mixed when the used pure metal or alloy is recovered, and to reproduce it to a target pure metal or alloy, lead with a high concentration must be removed. In addition, the specification for a lead impurity of lead-free solder is 0.1% or less (JIS 3282 (2006) Solder-Chemical Components and Shapes; ISO 9453 Second Edition), and thus a recycling method of efficiently removing a lead impurity with a high concentration of more than 0.1% in a recovered lead-free solder alloy is required.

However, the above-described methods need large-scale facilities as compared to the effect of removing lead and are high in capital investment cost and thus are industrially ineffective.

An object of the present invention is to provide an industrially excellent method for removing lead that is high in removal effect of lead, capable of implementing the removal even in small facilities and of suppressing capital investment cost.

The present inventors have diligently and repeatedly studied to solve the above-described subject, having led to the completion of a solution including the following constitutions.

The present invention provides a method of removing lead, the method comprising the steps of:

heating a material to be treated selected from the group consisting of a pure metal and an alloy to obtain a melt; and

contacting the melt with at least one of a metal halide and a metal oxyhalide to remove lead in the material to be treated.

Additionally, the present invention provides a reclaimed metal regenerated according to the above method.

The reclaimed metal means a solder, an alloy raw material and parts regenerated by the inventive method. These are not particularly limited and the following may be illustrated.

(1) Lead-free solder products (bar solder, wire solder, resin flux core solder, solder pastes, preforms, solder balls, solder powders, etc.).

(2) Alloy products (electric conduction products such as lead frames, connectors, electrodes, coils, fuses and cables, structural parts like bearings, bonding agents for metals, ceramics and composite materials and the like).

Additionally, the present invention involves a product in which plating, pre-soldering or component mounting is performed using the reclaimed metal.

The following can be illustrated as this product.

(1) Boards

The boards include, for example, tuner parts, BGA, CSP, MMC SiP, inverter parts, quartz resonators, LGA, POP, MCP, CPU, MPU, HIC, and the like.

(2) Electric Appliances

The electric appliances include, for example, mobile phones, DVC, DSC, TV, portable AV equipment, car navigation, PC, HDD, DVD, MD, clocks, microwave ovens, washing machines, refrigerators, air conditioners, audios, projectors, printers, scanners, copiers, telephones, PC cards, memories, terminal adaptors, and the like.

According to the present invention, a pure metal or alloy can be subjected to lead removal processing in large quantity at a relatively low temperature using comparatively small facilities and a method of removing lead with extremely high cost effectiveness can be provided. Therefore, the present invention is extremely beneficial industrially and an invention that remarkably promotes the recycling of industrial waste.

### BRIEF DESCRIPTION OF THE DRAWINGS

FIG. 1 shows a graph indicating the relationship between the content of lead and the amount of addition of tin chloride in Example 9 according to the present invention.

FIG. 2 shows a graph indicating the relationship between the content of lead and the reaction time in Example 10 according to the present invention.

### BEST MODE FOR CARRYING OUT THE INVENTION

### (Material to be Treated)

In the present invention, solder to be processed is a pure metal or an alloy having a melting point of less than 450° C. used for joining and applications for forming electrically conductive patterns. This solder includes solder referred to as “JIS 3282(2006) Solder-Chemical Components and Shapes” or “ISO 9453 Second Edition” and further includes solder like tin solder that is a pure metal.

The melting point of the solder is less than 450° C., more preferably 350° C. or less. More specifically, the invention is suitable for the deleading process of the following pure metals or alloy-based solder. In addition, the temperatures in the following parentheses show melting points.

In (156° C.), Sn (232° C.), Bi (271° C.), 89Sn8Zn3Bi (190 to 197° C.), 88Sn8In3.5Ag0.5Bi (196 to 206° C.), 91Sn9Zn(199° C.), 96Sn2.5Ag1Bi0.5Cu (213 to 218° C.), 95.8Sn3.5Ag0.7Cu (217 to 218° C.), 96.5Sn3Ag0.5Cu(216 to 220° C.), 95.5Sn3.8Ag0.7Cu (217 to 226° C.), 42Sn58Bi (138° C.), 52In48Sn (118° C.), 96.5Sn3.5Ag (221° C.), 95Sn5Sb (235 to 240° C.) and 99.3Sn0.7Cu (227° C.).

For solder, a material to be treated may be lead-free solder or lead-containing waste. Even when a material to be treated is lead-containing waste, the content of lead may be 0.1% or more or 0.1% or less.

The present invention is particularly suitable for deleading regeneration of solder and generally applicable to the deleading of a pure metal or alloy. The upper limit of the melting point of such alloy is not particularly limited, and is preferably 1500° C. or less, more preferably 1100° C. or less, from the point of easiness of deleading process. The lead content of alloy may be 0.1% or more or 0.1% or less.

Specifically, Cu—Sn-based, Cu—Be-based, Cu—Fe-based, Cu—Ni—Si-based alloys can be illustrated.

### (Heating Temperature)

The heating temperature for the material to be treated is selected according to the melting point of the material to be treated and is not particularly limited. However, in a preferred embodiment, the heating temperature for a material to be treated is from (P+0)° C. to (P+80)° C. when the melting point of the material to be treated is taken as P.

When the above material to be treated is solder and its melting point is from 118 to 240° C., the heating temperature for the material to be treated is preferably the melting point of the material to be treated or higher and 300° C. or lower. This makes it possible to most improve the productivity.

### (Deleading Agent)

In the present invention, the material to be treated is heated and melted and at least one of a metal halide and a metal oxyhalide is contacted with the melt.

The metal halides specifically include combinations of metals (M) and halogens (X) below. MX₂, MX₃, and MX₄ can be illustrated as chemical formulae.

The metals M include, but are not limited to, Ni, Sn, Sb, Cu, Ge, Bi, Zn, Ag and the like.

The halogens X include F, Cl, Br and I.

In addition, the deleading agent may contain two kinds or more of the metals M and contain two kinds or more of the halogen atoms X. Additionally, the deleading agent may contain two or more kinds of the metals M and two or more kinds of the halogens X.

The following compounds are specifically preferred as metal halides.

SbF₃, ZnF₂, AgF, GeF₂, SnF₂, CuF, CuF₂, NiF₂, BiF, BiF₂, SbCl₃, ZnCl₂, AgCl, GeCl₂, SnCl₂, SnCl₄, CuCl, CuCl₂, NiCl₂, BiCl, BiCl₂, SbBr₃, ZnBr₂, AgBr, GeBr₂, SnBr₂, CuBr, CuBr₂, NiBr₂, BiBr, BiBr₂, SbI₃, ZnI₂, AgI, GeI₂, SnI₂, CuI, CuI₂, NiI₂, BiI and BiI₂.

The metal oxyhalides specifically include combinations of metals (M) and halogens (X) below. MOX, MOX₂, MOX₃, M(OH)X₂, M(OH)X₃, MO(OH)X, M₄O₅X₂ and M₅O₉X₂ can be illustrated as chemical formulae.

The metals M include, but are not limited to, Ni, Sn, Sb, Cu, Ge, Bi and the like.

The halogens X include F, Cl, Br and I.

In addition, the deleading agent may contain two kinds or more of the metals M and contain two kinds or more of the halogen atoms X. Additionally, the deleading agent may contain two or more kinds of the metals M and two or more kinds of the halogens X.

The following compounds are specifically preferred as metal oxyhalides.

SbOX₃, Sb₄O₅X₂, GeOX₂, SnOX₂, SnO(OH)X, Sn(OH)X₃, Sn₅O₉X₂.4H₂O, SnO.SnX₂.3H₂O, 4SnO.SnX₂.6H₂O, 3SnO.2SnX₂.6H₂O, 3SnX₂.5SnO.3H₂O, 2SnX₂.7Sn(OH)₂, BiOX, (X═F, Cl, Br or I).

### (Solvent)

Metal halides and metal oxyhalides are mixed with solvents and then can be added to melts. This imparts flowability to a desalting agent, thereby improving operability. In this case, the solvents include silicone oils, mineral oils and engine oils made by petroleum refining, industrial lubricants such as spindle oils, machine oils, cylinder oils and gear oils, or synthetic lubricants and glycerin made by chemical synthesis, and the like. The operating temperature is set to be the decomposition temperatures or lower of these organic substances.

The total amount of addition of a metal halide and a metal oxyhalide is preferably 1 part by mass or more based on 100 parts by mass of a material to be treated and the deleading process can be further promoted by reaction for a long period of time.

Moreover, an excessive addition and an excessive treatment cost can be suppressed by making the total amount of addition of the metal halide and the metal oxyhalide 30 parts by mass or less.

### (Deleading Process)

In the present invention, deleading process can be performed by pouring a non-processed material that is heat-melted onto the above deleading agent and contacting. In a preferred embodiment, the material to be treated that is heat-melted and a deleading agent are mixed or particularly mixed by agitation. This makes it possible to remove lead by fire refining.

In the present invention, a deleaded material after deleading can be directly utilized in a subsequent step. However, preferably, quality governing is further carried out on the deleaded material to thereby be able to manufacture a reclaimed metal. In this case, a necessary metal component can be further added or an unnecessary metal component can be removed.

### Examples

The present invention will be set forth below in more detail by way of examples; however, the invention is by no means limited to the examples.

### Example 1

100 g of a lead-free solder alloy containing a high-concentration lead impurity (0.24%) was heat-melted at 300° C. using an evaporating dish, tin chloride was added thereto at 5% based on the mass of the lead-free solder alloy and then the resulting material was agitated and mixed with a stainless steel stirring rod for 5 minutes to thereby implement deleading process.

### Example 2

100 g of a lead-free solder alloy containing a high-concentration lead impurity (0.24%) was heat-melted at 300° C. using an evaporating dish, tin bromide was added thereto at 5% based on the mass of the lead-free solder alloy and then the resulting material was agitated and mixed with a stainless steel stirring rod for 5 minutes to thereby implement deleading process.

### Example 3

100 g of a lead-free solder alloy containing a high-concentration lead impurity (0.24%) was heat-melted at 300° C. using an evaporating dish, copper chloride was added thereto at 5% based on the mass of the lead-free solder alloy and then the resulting material was agitated and mixed with a stainless steel stirring rod for 5 minutes to thereby implement deleading process.

### Example 4

100 g of a lead-free solder alloy containing a high-concentration lead impurity (0.24%) was heat-melted at 300° C. using an evaporating dish, nickel chloride was added thereto at 5% based on the mass of the lead-free solder alloy and then the resulting material was agitated and mixed with a stainless steel stirring rod for 5 minutes to thereby implement deleading process.

### Example 5

100 g of a lead-free solder alloy containing a high-concentration lead impurity (0.24%) was heat-melted at 300° C. using an evaporating dish, antimony chloride was added thereto at 5% based on the mass of the lead-free solder alloy and then the resulting material was agitated and mixed with a stainless steel stirring rod for 5 minutes to thereby implement deleading process.

### Example 6

### 100 kg Scale

100 kg of a lead-free solder alloy containing a high-concentration lead impurity (0.33%) was heat-melted at 230° C. using a stainless steel vessel, tin chloride was added thereto at 5% based on the mass of the lead-free solder alloy and then the resulting material was agitated and mixed for 9 hours to thereby implement deleading process.

### Example 7

### 100 kg Scale

100 kg of a lead-free solder alloy containing a high-concentration lead impurity (0.33%) was heat-melted at 230° C. using a stainless steel vessel, tin oxychloride was added thereto at 5% based on the mass of the lead-free solder alloy and then the resulting material was agitated and mixed for 9 hours to thereby implement deleading process.

### Example 8

### 100 kg Scale

100 kg of a lead-free solder alloy containing a high-concentration lead impurity (0.12%) was heat-melted at 230° C. using a stainless steel vessel, tin chloride was added thereto at 1% based on the mass of the lead-free solder alloy and then the resulting material was agitated and mixed for 15 hours to thereby implement deleading process.

### Example 9

100 g of lead-free solder alloys containing a high-concentration lead impurity (0.24%) were heat-melted at 300° C. using evaporating dishes, tin chloride was added thereto at 1, 2, 3, 5, 8, 10, 15, 20 and 30% based on the mass of the lead-free solder alloy and then the resulting materials were agitated and mixed with a stainless steel stirring rod for 5 minutes to thereby implement deleading process.

### Example 10

100 g of lead-free solder alloys containing a high-concentration lead impurity (0.24%) were heat-melted at 300° C. using evaporating dishes, tin chloride was added thereto at 5% based on the mass of the lead-free solder alloy and then the resulting materials were each agitated and mixed with a stainless steel stirring rod for 1, 2, 5, 10, 20, 30 and 60 minutes to thereby implement deleading process.

Solders obtained in Examples 1 to 8 were analyzed by an optical emission metals analyzer (ARL4460, available from Thermo Scientific, Inc.) and the results of its chemical components are summarized in Table 1. In addition, the lead impurity concentrations in Examples 9 and 10 were also analyzed by the above analyzer.

TABLE 1

Chemical components; mass %

| Object | | Alloy | Sn | Pb | Sb | Bi | Cu | Au | In |
|---|---|---|---|---|---|---|---|---|---|
| Ex. 1 | Before deleading | Sn—Ag—Cu | Balance | 0.24 | 0.02 | 0.02 | 0.71 | 0.00 | (0.007) |
| SnCl2 | After deleading | | | 0.10 | 0.02 | 0.01 | 0.73 | 0.00 | (0.001) |
| Ex. 2 | Before deleading | | | 0.24 | 0.02 | 0.02 | 0.71 | 0.00 | (0.007) |
| SnBr2 | After deleading | | | 0.13 | 0.02 | 0.01 | 0.71 | 0.00 | (0.001) |
| Ex. 3 | Before deleading | | | 0.24 | 0.02 | 0.02 | 0.71 | 0.00 | (0.007) |
| CuCl2 | After deleading | | | 0.18 | 0.02 | 0.01 | 1.42 | 0.00 | (0.002) |
| Ex. 4 | Before deleading | | | 0.24 | 0.02 | 0.02 | 0.71 | 0.00 | (0.007) |
| NiCl2 | After deleading | | | 0.19 | 0.02 | 0.01 | 0.55 | 0.00 | (0.004) |
| Ex. 5 | Before deleading | | | 0.24 | 0.02 | 0.02 | 0.71 | 0.00 | (0.007) |
| SbCl2 | After deleading | | | 0.17 | 1.32 | 0.02 | 0.71 | 0.01 | (0.002) |

| JIS Z 3282* | | 0.10 | 0.10 | 0.10 | 0.3~0.7 | 0.05 | 0.10 |
|---|---|---|---|---|---|---|---|
| ISO 9453 | | | | | | | |
| Ex. 6 | Before deleading | 0.33 | 0.01 | 0.02 | 0.60 | 0.00 | (0.007) |
| SnCl2 | After deleading | 0.03 | 0.01 | 0.02 | 0.60 | 0.00 | (0.001) |
| Ex. 7 | Before deleading | 0.33 | 0.01 | 0.02 | 0.60 | 0.00 | (0.007) |
| Tin | After deleading | 0.11 | 0.01 | 0.01 | 0.62 | 0.00 | (0.002) |
| Oxy- | | | | | | | |
| chloride | | | | | | | |
| Ex. 8 | Before deleading | 0.12 | 0.01 | 0.03 | 0.68 | 0.00 | (0.003) |
| SnCl2 | After deleading | 0.03 | 0.01 | 0.03 | 0.65 | 0.00 | (0.000) |

Chemical components; mass %

| Object | | Alloy | Ag | Al | As | Cd | Fe | Ni | Zn |
|---|---|---|---|---|---|---|---|---|---|
| Ex. 1 | Before deleading | Sn—Ag—Cu | 3.07 | 0.000 | 0.00 | 0.000 | (0.009) | (0.008) | 0.000 |
| SnCl2 | After deleading | | 2.88 | 0.000 | 0.00 | 0.000 | (0.006) | (0.007) | 0.000 |
| Ex. 2 | Before deleading | | 3.07 | 0.000 | 0.00 | 0.000 | (0.009) | (0.008) | 0.000 |
| SnBr2 | After deleading | | 3.14 | 0.000 | 0.00 | 0.000 | (0.003) | (0.007) | 0.000 |
| Ex. 3 | Before deleading | | 3.07 | 0.000 | 0.00 | 0.000 | (0.009) | (0.008) | 0.000 |
| CuCl2 | After deleading | | 3.14 | 0.000 | 0.00 | 0.000 | (0.000) | (0.007) | 0.000 |
| Ex. 4 | Before deleading | | 3.07 | 0.000 | 0.00 | 0.000 | (0.009) | (0.008) | 0.000 |
| NiCl2 | After deleading | | 2.76 | 0.000 | 0.00 | 0.000 | (0.004) | (0.148) | 0.000 |
| Ex. 5 | Before deleading | | 3.07 | 0.000 | 0.00 | 0.000 | (0.009) | (0.008) | 0.000 |
| SbCl2 | After deleading | | 2.86 | 0.000 | 0.00 | 0.000 | (0.001) | (0.007) | 0.000 |

| | | | | | | | |
|---|---|---|---|---|---|---|---|
| JIS Z 3282* | 2.8~3.2 | 0.001 | 0.03 | 0.002 | 0.02 | 0.01 | 0.001 |
| ISO 9453 | | | | | | | |

| | | | | | | | | |
|---|---|---|---|---|---|---|---|---|
| Ex. 6 | Before | 2.95 | 0.000 | 0.00 | 0.000 | (0.009) | (0.007) | 0.000 |
| SnCl2 | deleading | | | | | | | |
| | After deleading | 2.85 | 0.000 | 0.00 | 0.000 | (0.001) | (0.007) | 0.000 |
| Ex. 7 | Before | 2.95 | 0.000 | 0.00 | 0.000 | (0.009) | (0.007) | 0.000 |
| Tin | deleading | | | | | | | |
| Oxy- | After deleading | 3.20 | 0.000 | 0.00 | 0.000 | (0.008) | (0.009) | 0.000 |
| chloride | | | | | | | | |
| Ex. 8 | Before | 3.27 | 0.000 | 0.00 | 0.000 | (0.003) | (0.005) | 0.000 |
| SnCl2 | deleading | | | | | | | |
| | After deleading | 2.97 | 0.000 | 0.00 | 0.000 | (0.001) | (0.007) | 0.000 |

*Values of chemical component without specific range means the maximum value.
0: Point Representation, Carry

The examination results of the chemical components of Examples 1 to 5 showed that Sn is good as the metal of the metal halides and tin chloride including chlorine is good as the halogen. Additionally, in CuCl₂, NiCl₂ and SbCl₂, each impurity component of Cu, Ni and Sb after deleading process was considerably increased. Therefore, for examples in which an impurity component was increased, the impurity component can be recycled by removal of the component or to a specific solder composition including its component. In Examples 6 and 8 (100 kg scale), the duration of the reaction time made it possible to decrease the lead content to 0.03%, although depending on the initial lead impurity concentration and the amount of addition of tin chloride.

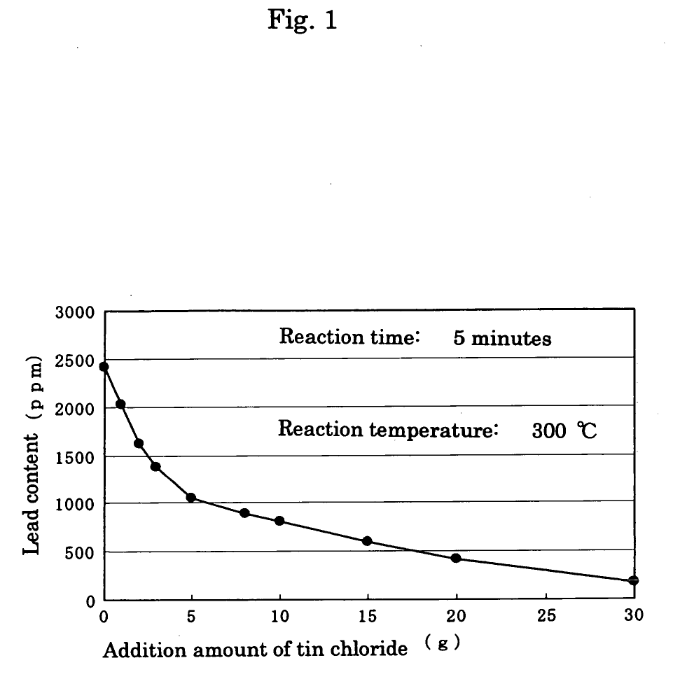

According to Example 9, the relationship between the amount of addition of tin chloride and the content of lead is shown in FIG. 1. The lead content was decreased with increasing amount of addition.

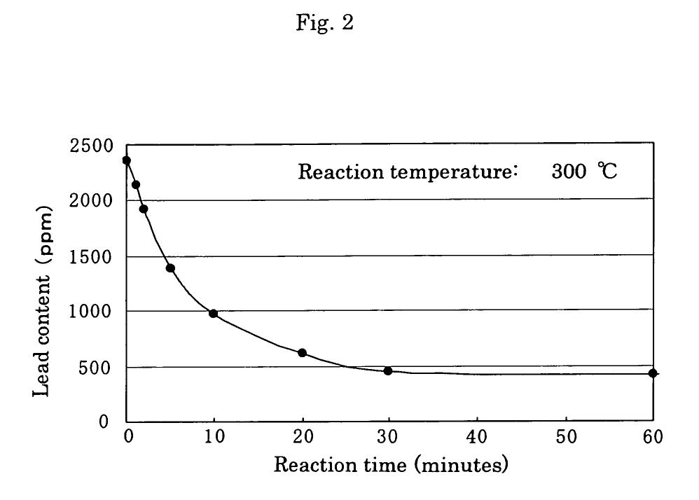

According to Example 10, the relationship between the reaction time and the content of lead when 5% tin chloride was added is shown in FIG. 2. The content of lead was decreased with the reaction time.

The Pb elimination factor (%) is shown in Table 2 from the analysis results of Examples 6 to 10.

TABLE 2

| Ex. 6 | Pb removal | 90.9 | | | | | | | | |
|---|---|---|---|---|---|---|---|---|---|---|
| | ratio | | | | | | | | | |
| | (%) | | | | | | | | | |
| Ex. 7 | Pb removal | 86.7 | | | | | | | | |
| | ratio | | | | | | | | | |
| | (%) | | | | | | | | | |
| Ex. 8 | Pb removal | 75.0 | | | | | | | | |
| | ratio | | | | | | | | | |
| | (%) | | | | | | | | | |
| Ex. 9 | Addition | 1 | 2 | 3 | 5 | 8 | 10 | 15 | 20 | 30 |
| | amount | | | | | | | | | |
| | Of SnCl₂ (%) | | | | | | | | | |
| | Pb removal | 16.0 | 32.7 | 42.8 | 56.6 | 63.2 | 66.5 | 75.4 | 82.4 | 92.5 |
| | ratio | | | | | | | | | |
| | (%) | | | | | | | | | |
| Ex. | Reaction time | 1 | 2 | 5 | 10 | 20 | 30 | 60 | | |
| 10 | (minutes) | | | | | | | | | |
| | Pb removal | 9.3 | 18.4 | 41.2 | 58.8 | 73.9 | 80.5 | 82.1 | | |
| | ratio | | | | | | | | | |
| | (%) | | | | | | | | | |

Example 10 shows that as the reaction time is elongated, the lead elimination factor is clearly improved. Moreover, from Example 9, the more the amount of addition of a deleading agent, the more the lead elimination factor is improved; the lead elimination factor can be improved also by suppressing the amount of addition to elongate the reaction time (Examples 6 and 8), thereby being capable of suppressing the material cost.

### INDUSTRIAL APPLICABILITY

The present invention is applicable to a recycling method that efficiently removes a lead impurity with a high concentration of more than 0.1% in lead-free solder as industrial applicability. In addition, the invention is a technique applicable to the removal of a lead impurity in similar pure metals or alloys.

1. A method of removing lead, the method comprising the steps of:
heating a material to be treated selected from the group consisting of a pure metal and an alloy to melt the material to obtain a melt; and
contacting the melt with at least one of a metal halide and a metal oxyhalide as a deleading agent to thereby remove lead in the material to be treated.

2. The method of claim 1, wherein the material to be treated comprises a solder.

3. The method of claim 1, wherein a mixture of a solvent and at least one of the metal halide and the metal oxyhalide is contacted with the melt.

4. The method of claim 1, wherein a total of added amounts of the metal halide and the metal oxyhalide added is from 1 to 30 parts by mass based on 100 parts by mass of the material to be treated.

5. The method of claim 1, wherein the metal halide comprises tin chloride.

6. The method of claim 1, wherein the heating temperature of the material to be treated is not lower than the melting point of the material to be treated and not higher than 300° C.

7. The method of claim 1, wherein a pure metal or an alloy is recycled by removing lead from the material to be treated.

8. The method of claim 1, further comprising the step of adjusting the chemical composition of the material such that a target composition is obtained after lead is removed.

9. A reclaimed metal recycled by the method of claim 1.

10. A product subjected to plating, pre-soldering or component mounting by use of the reclaimed metal of claim 9.
